(19) United States
(12) Patent Application Publication
(10) Pub. No.: US 2014/0121838 A1
(43) Pub. Date: May 1, 2014

(54) KIOSK HAVING AN AUTOMATIC HEIGHT ADJUSTMENT FUNCTION

(71) Applicant: Deok Keun Ahn, Incheon (KR)

(72) Inventor: Deok Keun Ahn, Incheon (KR)

(73) Assignee: ELI VISION CO., LTD, Incheon (KR)

(21) Appl. No.: 13/983,092

(22) PCT Filed: Feb. 20, 2012
(86) PCT No.: PCT/KR12/01259

§ 371 Date: Aug. 1, 2013

(30) Foreign Application Priority Data
Jul. 19, 2011 (KR) 10-2011-0071226

(51) Int. Cl. G05D 3/00

(52) U.S. Cl. CPC G05D 3/00
USPC 700/275

(57) ABSTRACT

An automatic height controllable kiosk is provided. The kiosk includes a moving pedestal, a support column having a control unit, an object sensor sensing access of a user, a pair of first rails installed on the support column, a vertically operating mechanism having a reduction motor, an operating gear, a chain, and a touch screen having, on a rear side thereof, a pair of second rails and a rack gear operatively coupled with the first rails and the operating gear, respectively, and having, on upper front and lower front sides thereof, respectively, a height sensor and a speaker, the height sensor being operated with a sensing event of the object sensor so as to sense height of a user.

### BACKGROUND OF THE INVENTION

1. Field of the Invention

The present invention relates, in general, to an automatic height controllable kiosk and, more particularly, to an automatic height controllable kiosk in which the height of a touch screen is automatically controlled with the aid of an object sensor and a height sensor, so that children, the elderly and disabled users, in addition to average-height people, can use the touch screen at a level suitable to their height. Further, the kiosk is configured such that, if the object sensor does not yet detect any object, the touch screen returns to the level that corresponds to the chest height of a average-height person, so even after a disabled person in a wheel chair or a child has used the touch screen, the average-height person who is the most common user can also use the touch screen conveniently. Further, since, after the height of the touch screen has been adjusted using the height sensor, the height of the touch screen does not change so long as the user is out of the detection range of the object sensor, a user can utilize the touch screen while his/her upper body moves freely, without interruption by the surroundings. Further, since the lifting action of the touch screen is carried out by a mechanism including an electric reduction motor, a chain, and a rack gear, the lifting action can be easily conducted irrespective of weight and size of the touch screen. Further, since the height sensor is installed on the upper front side of the touch screen so as to sense a front user at his/her chest height, the kiosk can be easily installed irrespective of the size of the touch screen, which is increasing according to recent trends. Further, since the kiosk can be carried to a desired position using moving rollers, displacement and maintenance can be easily performed.

2. Description of the Related Art

Although a variety of kiosks are currently available in the market, these kiosks are not ergonomically designed to take into account a user's height. Thus, when a user wants to use the kiosk with ease, he/she has to inconveniently adjust a touch screen to suit his/her height.

Further, since such a kiosk is installed to suit the average height of ordinary persons, for a tall person, a child, or the disabled, particularly those in a wheelchair, it is difficult to use the kiosk.

Thus, in order to solve this problem, a lower-height kiosk for the disabled and children has also been proposed, which however, is inconvenient in use for a normal person or a tall person. As a result, two types of kiosks for a normal-height person and below average height users, respectively should be installed, resulting in a great increase in the cost of installation and maintenance.

### SUMMARY OF THE INVENTION

Accordingly, the present invention has been made keeping in mind the above problems occurring in the related art, and the present invention is intended to propose an automatic height controllable kiosk, in which the height of a touch screen is automatically controlled with the aid of an object sensor and a height sensor so that children, the elderly and disabled users, in addition to average-height people, can use the touch screen at a level suitable to their height, and in which, if the object sensor does not yet detect any object, the touch screen returns to the level that corresponds to the chest height of an average-height person, so even after a disabled person in a wheel chair or a child has used the touch screen, the average-height person who is the most common user can also use the touch screen conveniently.

Another object of the present invention is to provide an automatic height controllable kiosk, in which, after the height of a touch screen has been adjusted using a height sensor, the height of the touch screen does not change so long as a user is out of the detection range of an object sensor, so the user can utilize the touch screen while his/her upper body moves freely, without interruption by the surroundings.

A further object of the present invention is to provide an automatic height controllable kiosk, in which the lifting action of a touch screen is carried out by a mechanism including an electric reduction motor, a chain, and a rack gear, so the lifting action can be easily conducted irrespective of weight and size of the touch screen, in which a height sensor is installed on the upper front side of the touch screen so as to sense a front user at his/her chest height, the kiosk can be easily installed irrespective of the size of the touch screen, which is increasing according to recent trends, and in which the kiosk can be carried to a desired position using moving rollers, so displacement and maintenance can be easily performed.

In order to achieve the above object, according to one aspect of the present invention, there is provided an automatic height controllable kiosk including: a moving pedestal having rollers for easy displacement; a support column vertically provided on the pedestal and having a control unit; an object sensor installed at the center of the support column so as to sense access of a user; a pair of first rails vertically installed at an upper front side of the support column; a vertically operating mechanism having a reduction motor, an operating gear, a chain operating the operating gear with the drive of the reduction motor, wherein the operating gear and the reduction motor are disposed on upper and lower sides, respectively, of the support column, the operating mechanism being operated by the operation of the control unit according to a sensing event of the object sensor; and a touch screen having, on a rear side thereof, a pair of second rails and a rack gear operatively coupled with the first rails and the operating gear, respectively, and having, on upper front and lower front sides thereof, respectively, a height sensor and a speaker, the height sensor being operated with a sensing event of the object sensor so as to sense height of a user, whereby, when the object sensor senses access of a user, the control unit controls the operating mechanism to vertically move the touch screen such that the touch screen is automatically moved towards the chest height of the user according to the sensing event of the height sensor with respect to the height of the user.

According to the automatic height controllable kiosk, the height of a touch screen is automatically controlled with the aid of an object sensor and a height sensor, so disabled users and children, as well as average-height users, can use the touch screen at the level suitable to their height. Further, if the object sensor does not yet detect any object, the touch screen returns to the level that corresponds to the chest height of a average-height person, so even after the child has used the touch screen, the average-height person that is the most common user can also use the touch screen conveniently.

Further, since, after the height of the touch screen has been adjusted using the height sensor, the height of the touch screen does not change so long as the user is out of the detection range of the object sensor, a user can utilize the touch screen while his/her upper body moves freely, without interruption by the surroundings.

Further, since the lifting action of the touch screen is carried out by a mechanism including an electric reduction motor, a chain, and a rack gear, the lifting action can be easily conducted irrespective of weight and size of the touch screen. Further, since the height sensor is installed on the upper front side of the touch screen so as to sense a front user at his/her chest height, the kiosk can be easily installed irrespective of the size of the touch screen, which is increasing according to recent trends. Further, since the kiosk can be carried to a desired position using moving rollers, displacement and maintenance can be easily performed.

### BRIEF DESCRIPTION OF THE DRAWINGS

The above and other objects, features and advantages of the present invention will be more clearly understood from the following detailed description when taken in conjunction with the accompanying drawings, in which:

FIG. 1 is affront view showing an automatic height controllable kiosk according to the present invention;

FIG. 2 is a view showing the state of a touch screen being raised; and

FIGS. 3 and 4 are views showing the state of the touch screen being lowered.

### DETAILED DESCRIPTION OF THE INVENTION

Reference will now be made in greater detail to a preferred embodiment of the invention, an example of which is illustrated in the accompanying drawings. Wherever possible, the same reference numerals will be used throughout the drawings and the description to refer to the same or like parts.

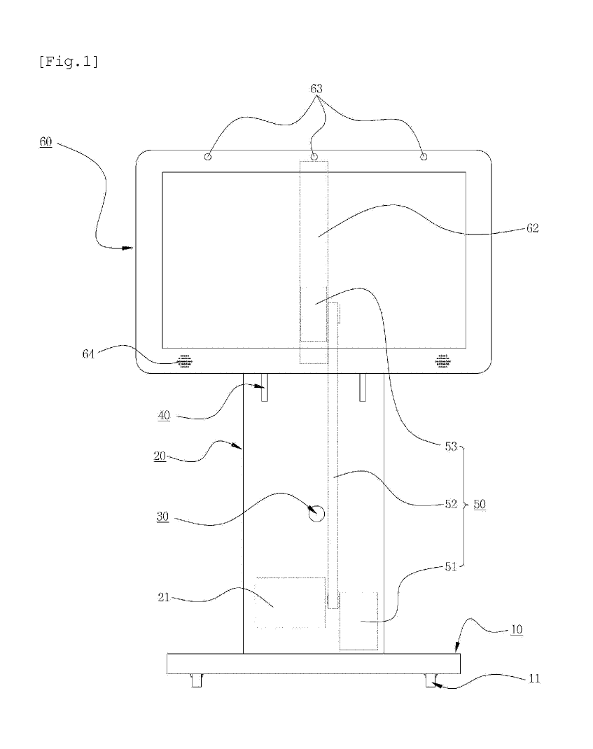

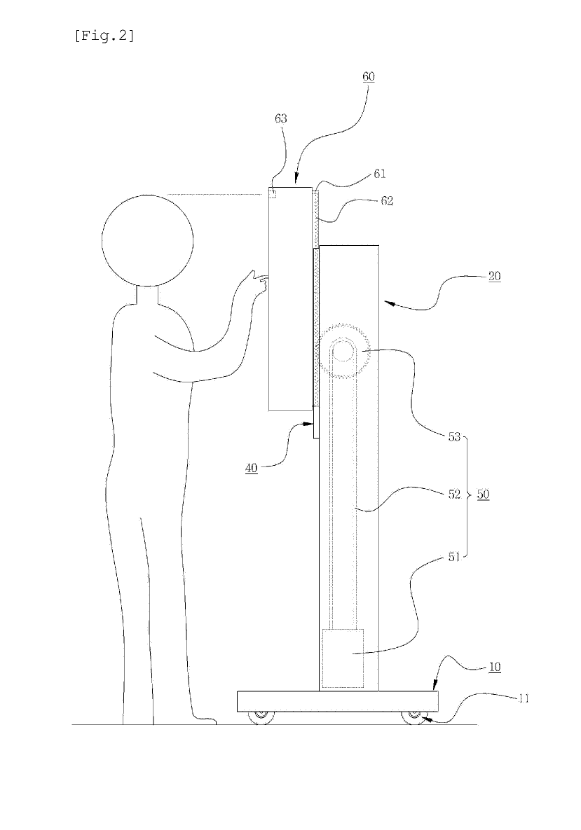

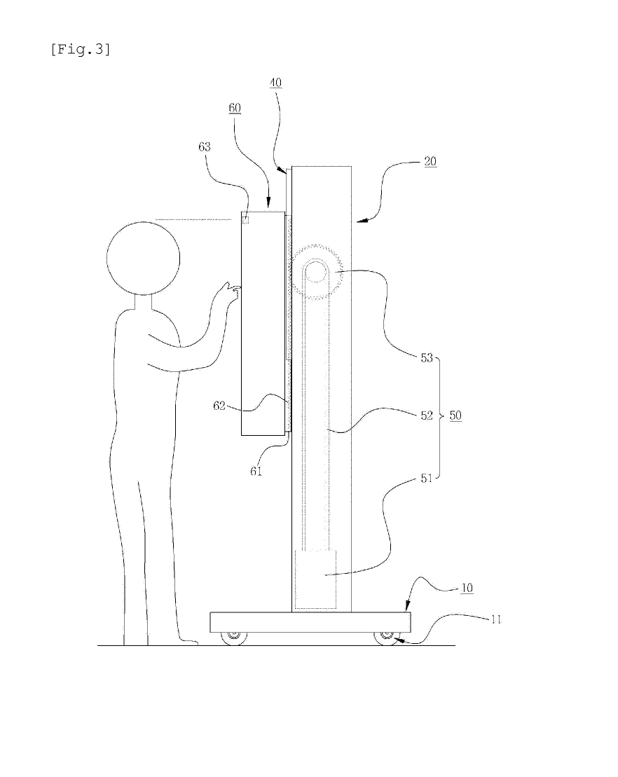

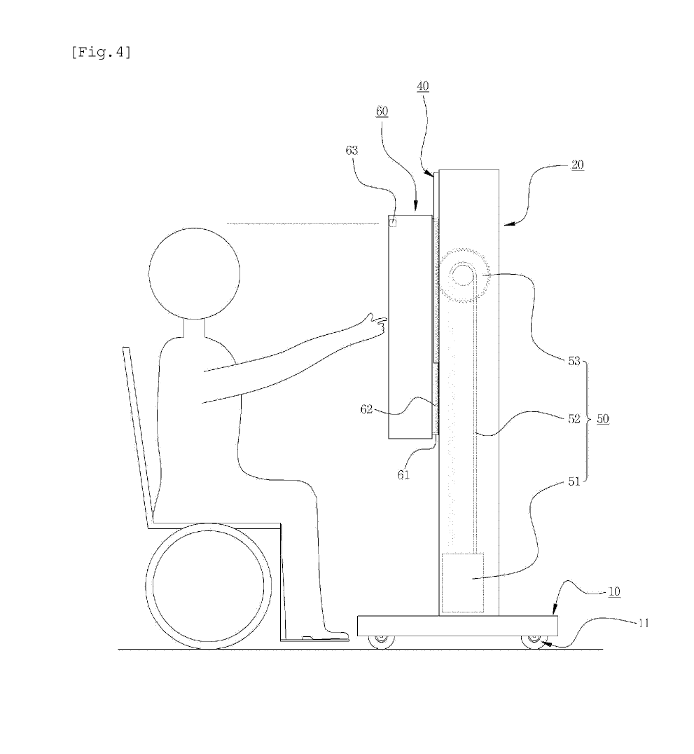

The present invention is directed to an automatic height controllable kiosk by which a user can search for desired information via a touch screen 60. As shown in FIGS. 1 to 4, the kiosk includes a pedestal 10, a support column 20, an object sensor 30, a pair of first rails 40, an operating mechanism 50, and the touch screen 60.

The pedestal 10 is a mounting base which has rollers 11 for easy displacement. With the provision of rollers 11, the kiosk can be easily moved for installation and maintenance.

The support column 20 is vertically provided on the pedestal 10 such that the touch screen 60 moves vertically therealong, and has a characteristic control unit 21 for the control of vertical movement of the touch screen 60.

The object sensor 30 is installed at the center of the support column 20 so as to sense access of a user. According to a sensing event of the object sensor 30, the control action of the control unit 21 is started to vertically move the touch screen 60.

The pair of first rails 40 is vertically installed at an upper front side of the support column 20 so as to aid the lifting action of the touch screen 60.

The vertically operating mechanism 50 is operated by the control action of the control unit with an sensing event of the object sensor 30 and characteristically has a reduction motor 51, an operating gear 53, and a chain connecting the reduction motor 51 and the operating gear 53, wherein the operating gear and the reduction motor are disposed on upper and lower sides, respectively, of the support column 20.

The touch screen 60 is a means for providing a user with information, and has a pair of second rails 61 and a rack gear 62 on a rear side thereof.

Here, the second rails 61 are correspondingly slide-coupled with the first rails 40 installed on the support column 20 so that the touch screen 60 slides along the first rails 40. The second rails in a pair are provided at a distance from each other on the rear side of the touch screen 60. The rack gear is a toothed gear that is operatively coupled with the operating gear 53 of the operating mechanism 50 in order to aid the vertical movement of the touch screen 60.

When the object sensor 30 senses the access of a user, the control unit 21 controls the reduction motor 51 to drive and rotate the operating gear via the chain. Then, the rack gear 62 is moved up and down in cooperation with the operating gear 53 so as to cause the touch screen 60 to be moved up and down. The second rails 62 are slide-coupled with the first rails 40, contributing to a stable vertical motion of the touch screen 60.

Here, the touch screen 60 is automatically moved towards the chest height of a user according to a sensing event of the height sensor 63 with respect to the user, that is, according to the height of user. Specifically, when the height sensor 63 installed on the upper side of the touch screen 60 senses a user, the touch screen 60 is moved up, whereas, if the height sensor 63 does not sense a user, the touch screen 60 is moved down.

Thus, when a sensing event of the height sensor 63 changes around a head of a user, that is, when the height sensor 63 senses a user by fits and starts as the touch screen 60 moves vertically, the touch screen 60 automatically stops its vertical motion with the control action of the control unit 21, and thus is located at the chest height of a user.

Further, a conventional speaker 64 is provided on a lower front side of the touch screen 60. A limit sensor (not shown) is preferably further provided on the touch screen 60 in order to prevent the touch screen from vertically moving out of an allowable range.

The touch screen 60 is preferably basically installed at the chest height of a user who has average height, i.e. about 170 centimeters. Further, it is preferred that, if the object sensor 30 does not yet sense a user, the control unit 21 controls the touch screen to automatically return to the chest height of a 170 cm tall user, so that average-height users can use the touch screen conveniently. With this configuration, even after a child has used the touch screen, the average-height user can also use the touch screen in a quick, convenient manner.

Further, it is preferred that the elevated height of the touch screen 60, which has been adjusted to suit the height of a user using the height sensor 63, do not change until the user moves out of a sensing range of the object sensor 30.

Thus, since, after the height of the touch screen 60 has been adjusted, the height of the touch screen 60 does not change so long as the user is out of the sensing range of the object sensor 30, a user can utilize the touch screen while his/her upper body moves freely. In this case, the height of the touch screen 60 does not change even when a surrounding tall man moves around the object sensor, so a user can use the touch screen conveniently.

Further, since the touch screen 60 is vertically driven by the operating mechanism including the electric reduction motor 51, the chain 52, and the rack gear 62 via the first and second rails 40 and 61, the lifting action of the touch screen can be easily conducted irrespective of weight and size of the touch screen 60. Further, since the height sensor 63 is installed on the upper front side of the touch screen 60 so as to sense a front user at his/her chest height, the kiosk can be easily installed irrespective of the size of the touch screen 60, which is increasing according to recent trends.

The operation of the kiosk having the above-mentioned configuration will be described.

First, when a user approaches the automatic height controllable kiosk, the object sensor 30 senses the user and the height sensor 63 is automatically operated so as to check the sensing of the user.

Here, since, if the height of the user is below average height, i.e. about 170 cm, the height sensor 63 cannot sense the user, according to automatic control of the control unit 21, the reduction motor 51 of the operating mechanism 50 is driven so as to rotate the operating gear 53 in a counterclockwise direction in cooperation with the chain 52. When the operating gear 53 rotates, the rack gear 62 is moved down so that the touch screen 60 is also moved down via the first and second rails 40 and 61.

When the height sensor 63 senses the user as the touch screen 60 moves down, that is, when the height sensor 62 is located around an end of the head of the user, according to the automatic control of the control unit 21, the operating mechanism 50 stops its operation and therefore a downward motion of the touch screen 60, so the touch screen 60 can be located at the chest height of the user.

In the meantime, since, if the height of a user is above the average height, i.e. about 170 cm, the height sensor 63 can sense the user, according to automatic control of the control unit 21, the reduction motor 51 of the operating mechanism 50 is driven so as to rotate the operating gear 53 in a clockwise direction in cooperation with the chain 52. When the operating gear 53 rotates, the rack gear 62 is moved up so that the touch screen 60 is also moved up via the first and second rails 40 and 61.

When the height sensor 63 is out of the sensing range with respect to the user as the touch screen 60 moves up, that is, when the height sensor 62 is located around an end of the head of the user, according to the automatic control of the control unit 21, the operating mechanism 50 stops its operation and therefore an upward motion of the touch screen 60, so the touch screen 60 can be located at the chest height of the user.

According to the automatic height controllable kiosk, the height of the touch screen 60 can be automatically controlled according to the height of a user, it is ensured that the user can utilize the touch screen with ease irrespective of his/her height.

Further, the problem that the touch screen 60 is located at a height which is inconvenient for typical users to use the touch screen, just after a tall person, a child or disabled person has used the kiosk, can be solved with the configuration that according to the automatic control of the control unit, the height of the touch screen 60 automatically returns to an initial position, i.e. the chest height of a user of average height, i.e. about 170 cm, at the same time when the former user moves out of the sensing range of the object sensor 30, so many users can use the kiosk in a quick, convenient manner.

Although a preferred embodiment of the present invention has been described for illustrative purposes, those skilled in the art will appreciate that various modifications, additions and substitutions are possible, without departing from the scope and spirit of the invention as disclosed in the accompanying claims.

1. An automatic height controllable kiosk comprising:
a moving pedestal having rollers for easy displacement;
a support column vertically provided on the pedestal and having a control unit;
an object sensor installed at the center of the support column so as to sense access of a user;
a pair of first rails vertically installed at an upper front side of the support column;
a vertically operating mechanism having a reduction motor, an operating gear, a chain operating the operating gear with the drive of the reduction motor, wherein the operating gear and the reduction motor are disposed on upper and lower sides, respectively, of the support column, the operating mechanism being operated by the operation of the control unit according to a sensing event of the object sensor; and
a touch screen having, on a rear side thereof, a pair of second rails and a rack gear operatively coupled with the first rails and the operating gear, respectively, and having, on upper front and lower front sides thereof, respectively, a height sensor and a speaker, the height sensor being operated with a sensing event of the object sensor so as to sense height of a user,
whereby, when the object sensor senses access of a user, the control unit controls the operating mechanism to vertically move the touch screen such that the touch screen is automatically moved towards the chest height of the user according to the sensing event of the height sensor with respect to the height of the user.

2. The kiosk according to claim 1, wherein the height of the touch screen is set to the chest height of a 170 cm tall user, and the touch screen is automatically height-controlled in such a manner that: when the height sensor senses a user, the touch screen is automatically moved up; when the height sensor does not yet sense a user, the touch screen is automatically moved down; when the height sensor is located around an end of a head of a user and thus senses the user by fits and starts, according to the control action of the control unit, the touch screen is stopped moving vertically and located to suit the height of a user; and
when the object sensor does not yet sense a user, according to automatic control of the control unit 21, the touch screen returns to the chest height of a 170 cm tall user for convenience of use.

3. The kiosk according to claim 1, wherein the height of the touch screen, which has been adjusted to suit the height of a user, does not change until the user moves out of a sensing range of the object sensor.

4. The kiosk according to claim 2, wherein the height of the touch screen, which has been adjusted to suit the height of a user, does not change until the user moves out of a sensing range of the object sensor.
